(19) United States
(12) Patent Application Publication
(10) Pub. No.: US 2026/0155304 A1
(43) Pub. Date: Jun. 4, 2026

(54) DIELECTRIC MATERIAL COMPRISING MAIN COMPONENT AND FIRST, SECOND, AND THIRD SUBCOMPONENTS, AND MULTILAYER CERAMIC ELECTRONIC DEVICE COMPRISING SAME

(71) Applicant: TAIYO YUDEN CO., LTD., Tokyo (JP)

(72) Inventors: Yamato SASAKI, Takasaki-shi (JP); Yasuhiro MATSUMOTO, Takasaki-shi (JP)

(21) Appl. No.: 19/384,213

(22) Filed: Nov. 10, 2025

Related U.S. Application Data
(63) Continuation of application No. 18/423,067, filed on Jan. 25, 2024.

(30) Foreign Application Priority Data
Feb. 3, 2023 (JP) 2023-015452

(51) Int. Cl. H01G 4/12; H01G 4/30

(52) U.S. Cl. CPC H01G 4/1227; H01G 4/1281; H01G 4/30

(57) ABSTRACT

A dielectric material includes a main component, a first subcomponent, a second subcomponent, and a third subcomponent. The main component includes barium titanate. The first subcomponent includes zirconium of 2 mol or more and 10 mol or less with respect to 100 mol of titanium of the dielectric material, so that a molar ratio of barium to a sum of titanium and zirconium in the dielectric material is more than 0.90 and less than 0.98. The second subcomponent includes gadolinium of 0.5 mol or more and 2 mol or less with respect to 100 mol of titanium in the dielectric material. The third subcomponent includes 0.01 mol or more and 2 mol or less of manganese with respect to 100 mol of titanium in the dielectric material. The dielectric material contains neither ytterbium nor ruthenium.

### CROSS-REFERENCE TO RELATED APPLICATION

This application is a continuation of U.S. patent application Ser. No. 18/423,067, filed Jan. 25, 2024, which is based upon and claims the benefit of priority of the prior Japanese Patent Application No. 2023-015452, filed on Feb. 3, 2023, the entire contents of which are incorporated herein by reference.

### FIELD

A certain aspect of the present disclosure relates to a dielectric material and a ceramic electronic device.

### BACKGROUND

Multilayer ceramic electronic devices such as multilayer ceramic capacitors are used in high frequency communication systems, typified by mobile phones (see, for example, Japanese Patent Application Publication No. 2017-114751 hereinafter referred to as Patent Document 1 and Japanese Patent Application Publication No. 2021-190669 hereinafter referred to as Patent Document 2).

### SUMMARY OF THE INVENTION

According to an aspect of the embodiments, there is provided a dielectric material including: a main component, a first subcomponent, a second subcomponent, and a third subcomponent, wherein the main component includes barium titanate, wherein the first subcomponent includes zirconium of 2 mol or more and 10 mol or less with respect to 100 mol of titanium of the dielectric material, so that a molar ratio of barium to a sum of titanium and zirconium in the dielectric material is more than 0.90 and less than 0.98, wherein the second subcomponent includes gadolinium of 0.5 mol or more and 2 mol or less with respect to 100 mol of titanium in the dielectric material, wherein the third subcomponent includes 0.01 mol or more and 2 mol or less of manganese with respect to 100 mol of titanium in the dielectric material.

According to another aspect of the embodiments, there is provided a multilayer ceramic electronic device including: the above-mentioned dielectric material.

### BRIEF DESCRIPTION OF THE DRAWINGS

FIG. 1 is a partial cross-sectional perspective view of a multilayer ceramic capacitor;

FIG. 2 is a cross-sectional view taken along line A-A in FIG. 1;

FIG. 3 is a cross-sectional view taken along line B-B in FIG. 1;

FIG. 4A illustrates a core-shell grain;

FIG. 4B schematically illustrates a cross sectional view of a dielectric layer;

FIG. 5 illustrates segregation;

FIG. 6 illustrates a flow of a manufacturing method of a multilayer ceramic capacitor;

FIG. 7A and FIG. 7B illustrate a forming process of an internal electrode;

FIG. 8 illustrates a crimping process; and

FIG. 9 illustrates a side margin.

### DETAILED DESCRIPTION

Multilayer ceramic electronic components are required to be able to achieve high dielectric constant and high resistivity.

Hereinafter, an exemplary embodiment will be described with reference to the accompanying drawings.

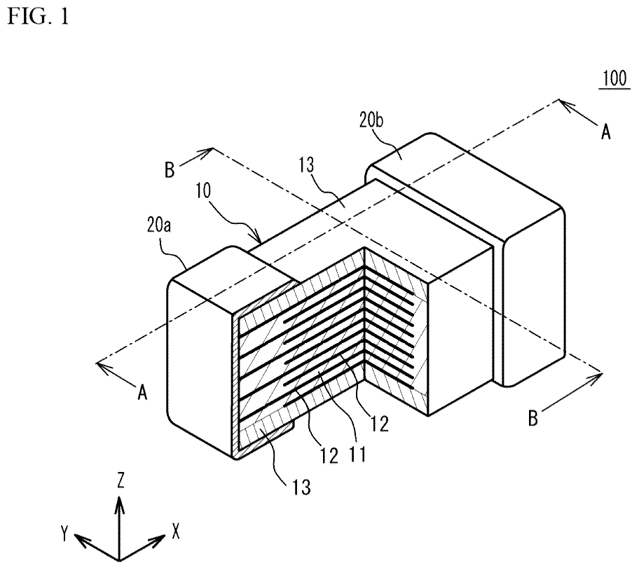

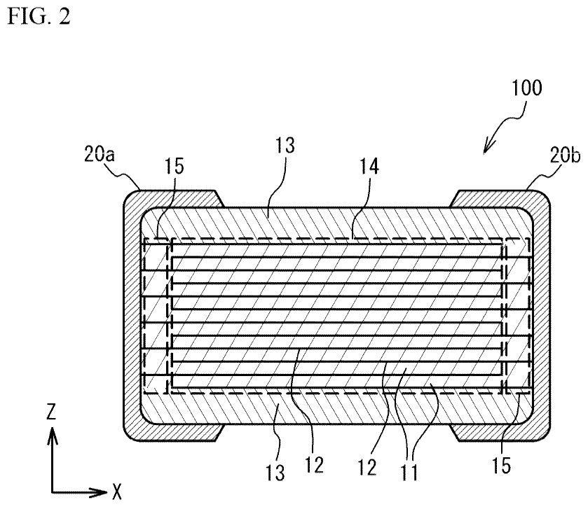

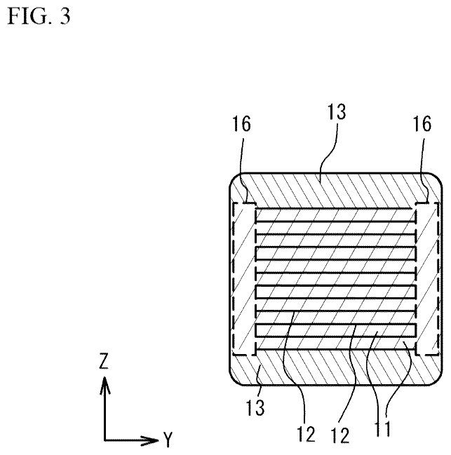

(Embodiment) FIG. 1 illustrates a perspective view of a multilayer ceramic capacitor 100 in accordance with an embodiment, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes a multilayer chip 10 having a rectangular parallelepiped shape, and external electrodes 20a and 20b that are respectively provided on two end faces of the multilayer chip 10 facing each other. Among four faces other than the two end faces of the multilayer chip 10, two faces other than the upper face and the lower face in the stacking direction are referred to as side faces. Each of the external electrodes 20a and 20b extends to the upper face and the lower face in the stacking direction and the two side faces of the multilayer chip 10. However, the external electrodes 20a and 20b are spaced from each other.

In FIG. 1 to FIG. 3, a Z-axis direction (first direction) is the stacking direction. The Z-axis direction is a direction in which internal electrode layers face each other. An X-axis direction (second direction) is a longitudinal direction of the multilayer chip 10. The X-axis direction is a direction in which the two end faces of the multilayer chip 10 are opposite to each other and in which the external electrode 20a is opposite to the external electrode 20b. A Y-axis direction (third direction) is a width direction of the internal electrode layers. The Y-axis direction is a direction in which the two side faces of the multilayer chip 10 are opposite to each other. The X-axis direction, the Y-axis direction and the Z-axis direction are vertical to each other.

The multilayer chip 10 has a structure designed to have dielectric layers 11 and internal electrode layers 12 alternately stacked. The dielectric layer 11 contains a ceramic material acting as a dielectric material. End edges of the internal electrode layers 12 are alternately exposed to a first end face of the multilayer chip 10 and a second end face of the multilayer chip 10 that is different from the first end face. The external electrode 20a is provided on the first end face. The external electrode 20b is provided on the second end face. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 is the same as the main component of the dielectric layer 11. Note that the structure is not limited to the configurations illustrated in FIG. 1 to FIG. 3 as long as the internal electrode layer 12 is exposed on two different faces and electrically connected to different external electrodes.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The main component of the internal electrode layer 12 is not particularly limited, but is a base metal such as Ni (nickel), Cu (copper), Sn (tin). As a main component of the internal electrode layers 12, noble metals such as Pt (platinum), Pd (palladium), Ag (silver), Au (gold), and alloys containing these may be used. The average thickness per layer of the internal electrode layer 12 in the Z-axis direction is, for example, 1.5 μm or less, 1.0 μm or less, or 0.7 μm or less. The thickness of the internal electrode layer 12 was determined by observing the cross section of the multilayer ceramic capacitor 100 with a SEM (scanning electron microscope), measuring the thickness at 10 points for each of the 10 different internal electrode layers 12, and calculating the average value of all the measurement points.

A main component of the dielectric layer 11 is a ceramic material having a perovskite structure expressed by a general formula ABO₃. The perovskite structure includes ABO_{3-α} having an off-stoichiometric composition. For example, the ceramic material is such as barium titanate. For example, the concentration of the ceramic material in the dielectric layer 11 is 90 at % or more. The thickness of the dielectric layer 11 is, for example, 10.0 μm or less, 5.0 μm or less, 3.0 μm or less, and 1.0 μm or less. The thickness of the dielectric layer 11 is determined by observing the cross section of the multilayer ceramic capacitor 100 with a SEM (scanning electron microscope), measuring the thickness of each of the 10 different dielectric layers 11 at 10 points, and calculating the average value of all measurement points.

Additives may be added to the dielectric layer 11. As additives to the dielectric layer 11, zirconium (Zr), magnesium (Mg), manganese (Mn), molybdenum (Mo), vanadium (V), chromium (Cr), rare earth elements (scandium (Sc), lanthanum (La), cerium (Ce), praseodymium (Pr), neodymium (Nd), promethium (Pm), yttrium (Y), samarium (Sm), europium (Eu), gadolinium (Gd), terbium (Tb), dysprosium (Dy), holmium (Ho), erbium (Er), thulium (Tm), ytterbium (Yb) and ruthenium (Lu)) or an oxide of cobalt (Co), nickel (Ni), lithium (Li), boron (B), sodium (Na), potassium (K) or silicon (Si), or a glass including cobalt, nickel, lithium, boron, sodium, potassium or silicon.

As illustrated in FIG. 2, the section where the internal electrode layers 12 connected to the external electrode 20a faces the internal electrode layers 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no capacity is generated.

As illustrated in FIG. 3, in the multilayer chip 10, a side margin 16 is a section provided so as to cover the ends (ends in the Y-axis direction) of the two side faces of the dielectric layers 11 and the internal electrode layers 12. That is, the side margin 16 is a section provided outside the capacity section 14 in the Y-axis direction. The side margin 16 is also a section where no capacity is generated.

In the dielectric layer 11, it is preferable that at least a portion of the dielectric crystal containing the base material and the subcomponent includes core-shell grains having a core-shell structure.

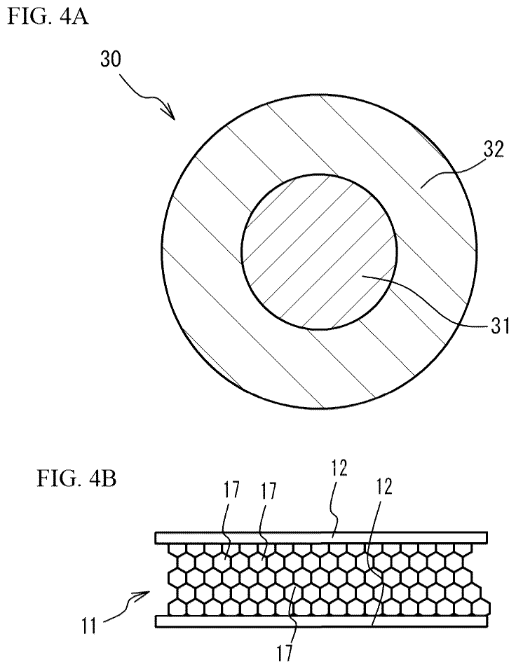

As illustrated in FIG. 4A, a core-shell grain 30 includes a substantially spherical core portion 31 and a shell portion 32 that surrounds and covers the core portion 31. The core portion 31 is a crystalline portion in which the additive compound is not solid-solved or the amount of the solid-solve additive compound is small. The shell portion 32 is a crystalline portion in which the additive compound is solid-solved and has a higher concentration of the additive compound than the concentration of the additive compound in the core portion 31.

FIG. 4B is a schematic cross-sectional view of the dielectric layer 11. As illustrated in FIG. 4B, the dielectric layer 11 includes a plurality of dielectric grains 17 of which a main component is ceramic. At least some of these dielectric grains 17 are the core-shell grains 30 described in FIG. 4A.

Multilayer ceramic capacitors are used in high-frequency communication systems, such as mobile phones, to remove noise. Multilayer ceramic capacitors are also used in electronic circuits related to human life, such as in-vehicle electronic control devices. Multilayer ceramic capacitors are required to have high reliability, and techniques for improving reliability have been disclosed.

For the dielectric of multilayer ceramic capacitors, a sintered body with a core-shell structure has been used, in which the core is barium titanate and the core is surrounded by a shell in which various additives are solid-solved. By creating a core-shell structure having a barium titanate core and a shell containing various additives, it is possible to obtain a material that has a high dielectric constant, excellent temperature characteristics, and a stable microstructure.

Magnesium is a typical additive of the shell portion. However, since magnesium is a simple acceptor that does not fluctuate in valence and forms a solid solution to form oxide ion defects, the reliability reaches a plateau. Recently, it was reported in Patent Document 2 that by co-doping zirconium and europium, it is possible to obtain a material that has both good dielectric constant temperature characteristics and reliability. On the other hand, Patent Document 2 points out that the addition of europium deteriorates the insulation properties. This is considered to be due to the fact that europium can be in a divalent or trivalent state, so that hopping conduction becomes noticeable.

In contrast, the multilayer ceramic capacitor 100 according to the present embodiment has a configuration that can achieve a high dielectric constant and high reliability. The details will be explained below.

Specifically, the dielectric layer 11 has a main component containing barium titanate. Further, the dielectric layer 11 includes a first subcomponent, a second subcomponent, and a third subcomponent. The first subcomponent is present in the dielectric layer 11 in an amount of 2 mol or more and 10 mol or less with respect to 100 mol of titanium. The forst subcomponent includes zirconium so that the molar ratio of barium to the sum of titanium and zirconium in the dielectric layer 11 (hereinafter also referred to as Ba/(Ti+Zr)) is greater than 0.90 and less than 0.98. The second subcomponent contains gadolinium in an amount of 0.5 mol or more and 2 mol or less with respect to 100 mol of titanium in the dielectric layer 11. The third subcomponent includes manganese in an amount of 0.01 mol or more and 2 mol or less with respect to 100 mol of titanium in the dielectric layer 11. With this configuration, high dielectric constant and high reliability can be achieved.

By setting a lower limit on the amount of zirconium with respect to titanium, dielectric loss (tan δ) can be kept low. From the viewpoint of keeping tan δ low, in the dielectric layer 11, the added amount of zirconium with respect to 100 mol of titanium is preferably 2 mol or more, more preferably 3 mol or more. Further, the Ba/(Ti+Zr) ratio is preferably 0.98 or less, more preferably 0.96 or less.

By setting an upper limit on the amount of zirconium with respect to titanium, diffusion of zirconium to the core portion 31 is suppressed, and the core-shell structure of the core-shell grain 30 is maintained. Thereby, excellent temperature characteristics can be achieved. In the dielectric layer 11, the added amount of zirconium with respect to 100 mol of titanium is preferably 10 mol or less, more preferably 8 mol or less. Further, the Ba/(Ti+Zr) ratio is preferably 0.90 or more, more preferably 0.92 or more.

By containing gadolinium as a rare earth element in the dielectric layer 11, reduction of barium titanate can be suppressed during firing. Thereby, tan δ can be kept low. Furthermore, since the dielectric layer 11 contains gadolinium, high resistivity is achieved and insulation is improved. This is thought to be because gadolinium can only have a trivalent valence, and the absence of valence fluctuations contributes to improved insulation. From the viewpoint of improving insulation, in the dielectric layer 11, the amount of gadolinium with respect to 100 mol of titanium is preferably 0.5 mol or more, more preferably 1 mol or more.

On the other hand, by setting an upper limit on the amount of gadolinium, substitutional solid solution of gadolinium at the A site of barium titanate can be suppressed, and deterioration of insulation properties can be suppressed. In the dielectric layer 11, the amount of gadolinium with respect to 100 mol of titanium is preferably 2 mol or less, more preferably 1 mol or less.

By setting a lower limit on the amount of manganese added, reduction of barium titanate during firing can be suppressed. Thereby, tan δ can be kept low and insulation properties can be improved. From the viewpoint of improving insulation, in the dielectric layer 11, the amount of gadolinium with respect to 100 mol of titanium is preferably 0.01 mol or more, more preferably 0.02 mol or more.

On the other hand, by setting an upper limit on the amount of manganese added, it is possible to suppress hopping conduction caused by variations in the valence of manganese, and it is possible to suppress deterioration of insulation properties. Furthermore, since the amount of manganese acting as an acceptor can be suppressed, the generation of oxide ion vacancies can be suppressed, and a decrease in the dielectric constant can be suppressed. From the viewpoint of suppressing insulation deterioration and dielectric constant reduction, in the dielectric layer 11, the amount of manganese with respect to 100 mol of titanium is preferably 2 mol or less, more preferably 1 mol or less.

Note that the dielectric layer 11 preferably contains a fourth subcomponent containing vanadium in an amount of 0.5 mol or less with respect to 100 mol of titanium. When the dielectric layer 11 contains vanadium, the resistivity becomes high. This is thought to be because vanadium is distributed at grain boundaries and grain boundary multiple points, increasing the width of the double Schottky barrier at grain boundaries, and making it difficult for tunnel current to occur. The term “grain boundary multiple point” refers to a region adjacent to three or more dielectric grains, such as a grain boundary triple point, for example. On the other hand, by setting an upper limit on the amount of vanadium added in the dielectric layer 11, replacement solid solution of vanadium in the shell portion 32 is suppressed, and high resistivity is maintained. The amount of vanadium added in the dielectric layer 11 is more preferably 0.3 mol or less, and even more preferably 0.2 mol or less, with respect to 100 mol of titanium.

In order to obtain the effect of vanadium addition, it is preferable to set a lower limit to the amount of vanadium added. The amount of vanadium added to 100 mol of titanium is preferably 0.05 mol or more, more preferably 0.075 mol or more, and even more preferably 0.1 mol or more.

In the core-shell grain 30, the total concentration of zirconium and manganese in the core portion 31 is preferably lower than the total concentration of zirconium and manganese in the shell portion 32. The reason is that when the concentrations of zirconium, manganese, and vanadium in the core portion 31 become high, they interfere with polarization reversal of barium titanate, and the dielectric constant decreases significantly.

The dielectric layer 11 may contain a rare earth element in addition to gadolinium. However, if a rare earth element other than gadolinium is included, there is a risk that reliability may be lowered, so it is preferable that the amount of rare earth elements other than gadolinium in the dielectric layer 11 is smaller than that of gadolinium.

The valence of vanadium contained in the dielectric layer 11 is preferably pentavalent. The reason is that pentavalent vanadium substitutes and forms a solid solution in the titanium site of barium titanate, and acts to reduce the oxide ion vacancy concentration. For example, the valence of vanadium in the dielectric layer 11 can be determined by valence analysis using TEM-EELS.

In the core-shell grain 30, the total concentration of zirconium, manganese, and vanadium in the core portion 31 is preferably lower than the total concentration of zirconium, manganese, and vanadium in the shell portion 32. The reason is that when the concentrations of zirconium, manganese, and vanadium in the core portion 31 become high, they interfere with polarization reversal of barium titanate, and the dielectric constant decreases significantly.

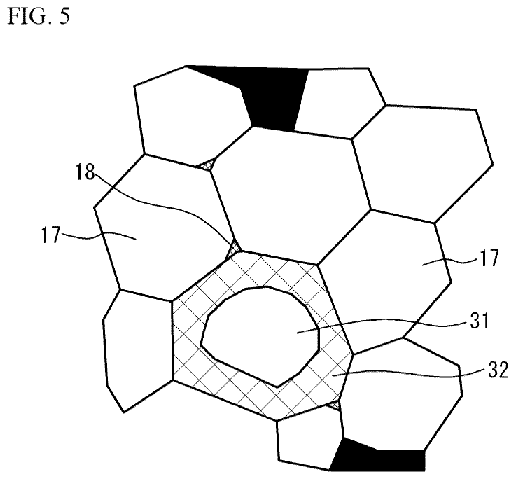

As illustrated in FIG. 5, segregated substances 18 may be generated at the grain boundaries of the plurality of dielectric grains 17. For example, the segregated substance 18 may occur at a grain boundary multiple point that is a grain boundary between three or more dielectric grains 17. Preferably, the segregated substance 18 includes the third subcomponent and the fourth subcomponent. Specifically, it is preferable that the segregated substance 18 contains manganese and vanadium. This is because additives such as manganese and vanadium segregate at the grain boundaries, forming double Schottky barriers at the grain boundaries of barium titanate, contributing to improving insulation resistance.

It is preferable that the dielectric layer 11 contains a fifth subcomponent containing silicon, and the segregated substance 18 contains the fifth subcomponent. Specifically, it is preferable that the segregated substance 18 contains silicon. The reason is that by segregating silicon at grain boundaries, the silicon acts as a sintering aid and significantly improves sinterability.

It is preferable that at least one of the plurality of dielectric grains 17 is a sub-crystal particle of at least one of BaTi₂O₅, BaTi₄O₉, BaTi₅O₁₁, BaTi₆O₁₃, Ba₄Ti₁₁O₂₆, Ba₄Ti₁₂O₂₇, Ba₄Ti₁₃O₃₀, Ba₄Ti₁₄O₂₇, or Ba₆Ti₁₇O₄₀. These sub-crystal grains have higher resistivity than barium titanate that has been fired in a reductive atmosphere, and thus contribute to improving the insulation of the multilayer ceramic capacitor 100.

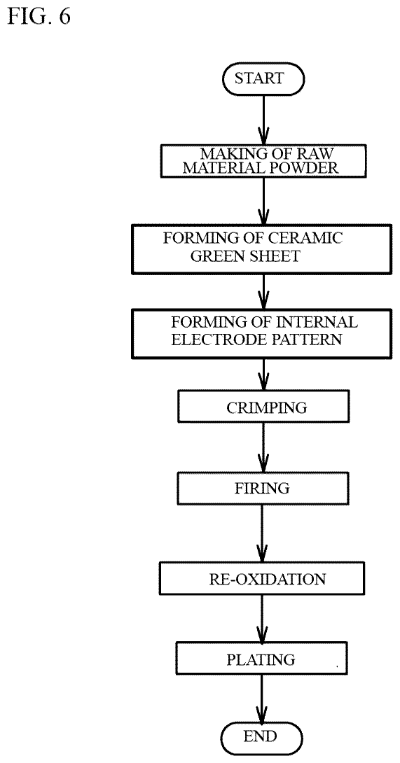

Next, a description will be given of a manufacturing method of the multilayer ceramic capacitors 100. FIG. 6 illustrates a manufacturing method of the multilayer ceramic capacitor 100.

(Making process of raw material powder) A dielectric material for forming the dielectric layer 11 is prepared. An A site element and a B site element are included in the dielectric layer 11 in a sintered phase of grains of ABO₃. For example, barium titanate is tetragonal compound having a perovskite structure and has a high dielectric constant. Generally, barium titanate is obtained by reacting a titanium material such as titanium dioxide with a barium material such as barium carbonate and synthesizing barium titanate. Various methods can be used as a synthesizing method of the ceramic structuring the dielectric layer 11. For example, a solid-phase method, a sol-gel method, a hydrothermal method or the like can be used. The embodiments may use any of these methods.

A predetermined additive compound is added to the obtained dielectric powder according to the purpose. As additives to the dielectric layer 11, zirconium, hafnium, magnesium, manganese, molybdenum, vanadium, chromium, rare earth elements (scandium, lanthanum, cerium, praseodymium, neodymium, promethium, yttrium, samarium, europium, gadolinium, terbium, dysprosium, holmium, erbium, thulium, ytterbium and ruthenium) or an oxide of cobalt, nickel, lithium, boron, sodium, potassium or silicon, or a glass including cobalt, nickel, lithium, boron, sodium, potassium or silicon.

For example, a ceramic material is prepared by wet-mixing a compound containing an additive compound with a ceramic raw material powder, drying and pulverizing the mixture. For example, the ceramic material obtained as described above may be pulverized to adjust the particle size, if necessary, or may be combined with a classification process to adjust the particle size. Through the above steps, a dielectric material is obtained.

The obtained dielectric material includes the main component, the first subcomponent, the second subcomponent, the third subcomponent, and the fourth subcomponent. The main component includes barium titanate. The first subcomponent includes 2 mol or more and 10 mol or less of zirconium with respect to 100 mol of titanium in the dielectric material such that the Ba/(Ti+Zr) ratio in the dielectric material is more than 0.90 and less than 0.98. The second subcomponent includes 0.5 mol or more and 2 mol or less of gadolinium with respect to 100 mol of titanium in the dielectric material. The third subcomponent includes 0.01 mol or more and 2 mol or less of manganese with respect to 100 mol of titanium in the dielectric material. The fourth subcomponent includes 0.5 mol or less of vanadium with respect to 100 mol of titanium in the dielectric material.

Next, a dielectric pattern material for forming the side margin 16 is prepared. The dielectric pattern material includes the main component ceramic powder of the side margin 16. As the main component ceramic powder, for example, the main component ceramic powder of the dielectric material may be used. Predetermined additive compounds are added depending on the purpose.

(Forming process of ceramic green sheet) Next, a binder such as polyvinyl butyral (PVB) resin, an organic solvent such as ethanol or toluene, and a plasticizer are added to the obtained dielectric material and wet-mixed. Using the obtained slurry, a ceramic green sheet 51 is formed on the substrate by, for example, a die coater method or a doctor blade method, and dried. The substrate is, for example, polyethylene terephthalate (PET) film. The process is not illustrated.

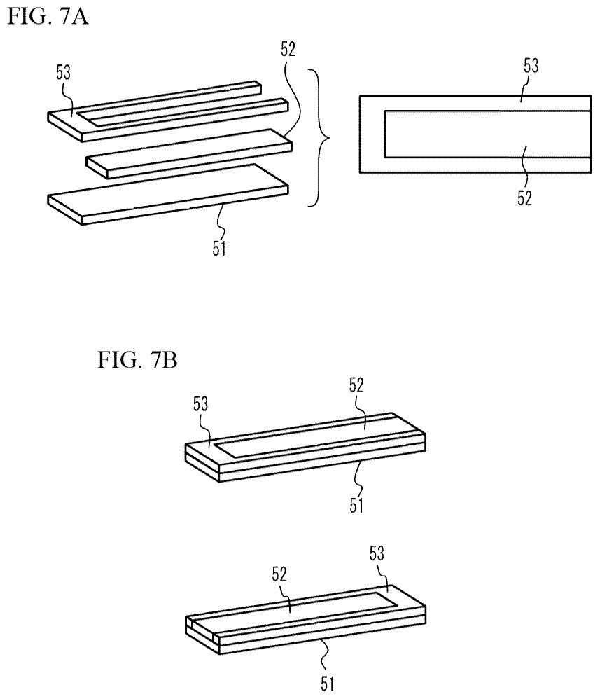

(Forming process of internal electrode pattern) Next, as illustrated in FIG. 7A, a metal conductive paste for forming internal electrodes containing an organic binder is printed on the surface of the ceramic green sheet 51 by screen printing, gravure printing, or the like to form internal electrodes. Thus, an internal electrode pattern 52 for layers is arranged. Ceramic particles may be added to the metal conductive paste as a co-material. The main component of the ceramic particles is not limited. However, it is preferable that the main component of the ceramic particles is the same as the main component of the dielectric layer 11.

Next, a binder such as ethyl cellulose and an organic solvent such as terpineol are added to the dielectric pattern material obtained in the making process of the raw material powder, and the mixture is kneaded in a roll mill to form a dielectric pattern paste for the reverse pattern layer. As illustrated in FIG. 7A, a dielectric pattern 53 is formed by printing the resulting slurry in the peripheral region, where the internal electrode pattern 52 is not printed, on the ceramic green sheet 51 to cause the dielectric pattern 53 and the internal electrode pattern 52 to form a flat surface. The ceramic green sheet 51 on which the internal electrode pattern 52 and the dielectric pattern 53 are printed is referred to as a stack unit.

Thereafter, as illustrated in FIG. 7B, a predetermined number of stack units are stacked so that the internal electrode layers 12 and the dielectric layers 11 are alternated with each other and the end edges of the internal electrode layers 12 are alternately exposed to both end faces in the length direction of the dielectric layer 11 so as to be alternately led out to a pair of the external electrodes 20a and 20b of different polarizations. For example, the number of the internal electrode pattern 52 is 100 to 500.

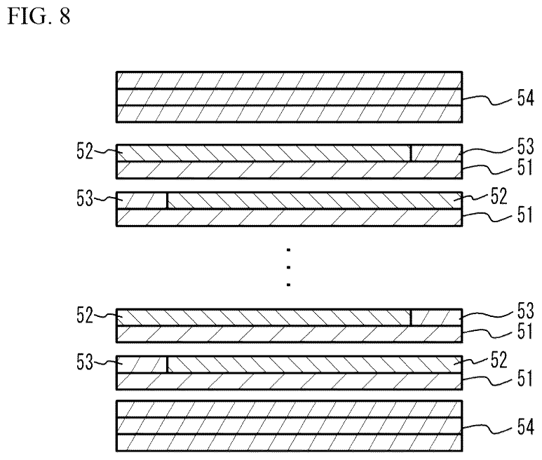

(Crimping process) Next, as illustrated in FIG. 8, a predetermined number (for example, 2 to 10) cover sheet 54 are stacked on the stacked stack units and under the stacked stack units. After that, the stacked structure is thermally crimped. The above-mentioned dielectric material or the above-mentioned dielectric pattern material can be used as the ceramic material of the cover sheets 54.

(Firing process) The binder is removed from the resulting ceramic multilayer structure in N₂ atmosphere. After that, a metal paste to be the base layer of the external electrodes 20a and 20b is applied to the resulting ceramic multilayer by a dipping or the like. The resulting ceramic multilayer structure is fired in a reducing atmosphere with an oxygen partial pressure of 10-5 to 10-8 atm in a temperature of 1150° C. to 1250° C. for 5 minutes to 10 hours.

(Re-oxidation process) In order to return oxygen to the partially reduced main phase barium titanate of the dielectric layer 11 fired in a reducing atmosphere, N₂ and water vapor are mixed at about 1000° C. to an extent that the internal electrode layer 12 is not oxidized, heat treatment may be performed in gas or in the atmosphere at 500° C. to 700° C. This process is called a re-oxidation process.

(Plating process) After that, metal layers such as copper, nickel, and tin may be formed on the base layer of the external electrodes 20a and 20b by plating. Thus, the multilayer ceramic capacitor 100 is manufactured.

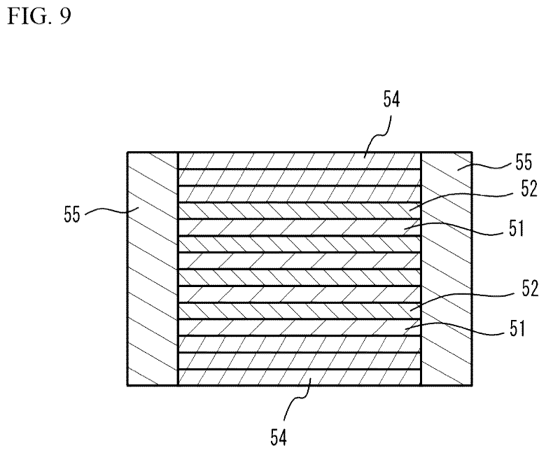

The side margin portion may be attached or coated on the side surface of the laminated portion. Specifically, as illustrated in FIG. 9, a multilayer portion is obtained by alternately stacking the ceramic green sheets 51 and the internal electrode patterns 52 having the same width as the ceramic green sheets 51. Next, a sheet formed of dielectric pattern paste may be attached as a side margin portion 55 to the side surface of the multilayer portion.

Note that in the above, the base layer for the external electrode and the ceramic multilayer structure are fired at the same time, but the method is not limited thereto. For example, after firing the ceramic multilayer structure, a paste of Ni, Cu, and Ag may be applied and baked, or terminal electrodes may be formed by plating or sputtering techniques.

Note that in each of the above embodiments, a multilayer ceramic capacitor has been described as an example of a multilayer ceramic electronic device, but the present invention is not limited thereto. For example, other multilayer ceramic electronic devices such as varistors and thermistors may be used.

### Examples

(Example 1) Powders of titanium oxide (TiO₂), zirconium oxide (ZrO₂), gadolinium oxide (Gd₂O₃), manganese carbonate (MnCO₃), and silicon oxide (SiO₂) were added to barium titanate (BaTiO₃) powder. The amount of zirconium added was 2 mol with respect to 100 mol of titanium. The molar ratio of barium to titanium (Ba/Ti ratio) was set to 1. The molar ratio of barium to the sum of titanium and zirconium (Ba/(Ti+Zr)) was set to 0.980. The amount of gadolinium added was 1 mol with respect to 100 mol of titanium. The amount of manganese added was 0.5 mol with respect to 100 mol of titanium.

These were mixed with ethanol, toluene, and PVB (polyvinyl butyral) resin. Mixing was performed using a ball mill using YSZ (yttria stabilized zirconia) balls to prepare a dielectric slurry. This slurry was formed into a ceramic green sheet with a thickness of 2.5 μm using a die coater. After drying this ceramic green sheet, nickel paste was printed to form an internal electrode pattern. Eleven layers of the obtained stacked units were stacked, and thickly stacked ceramic green sheets on the top and bottom of which no internal electrode pattern was formed were pressed together, and then cut into small pieces. Thereafter, Ni paste was dipped on the two end faces as a conductive paste for external electrodes, and degreasing was performed in nitrogen gas. The degreased piece was sintered by firing at 1280° C. for 2 hours in a N₂—H₂-H₂O mixed gas controlled to have an oxygen partial pressure that would not oxidize nickel, thereby producing a multilayer ceramic capacitor.

The size of the manufactured multilayer ceramic capacitor was 1005 shape (1.0 mm×0.5 mm×0.5 mm). The thickness of each dielectric layer was 2.0 μm. Thereafter, heat treatment was performed at 850° C. for 2 hours in a mixed gas of nitrogen and several ppm of oxygen, and reoxidation treatment was performed to compensate for oxygen ions lost from the barium titanate crystal.

(Example 2) In Example 2, the amount of zirconium added was 4 mol with respect to 100 mol of titanium. The molar ratio of barium to the sum of titanium and zirconium (Ba/(Ti+Zr)) was set to 0.960. Other conditions were the same as in Example 1.

(Example 3) In Example 3, the amount of zirconium added was 8 mol with respect to 100 mol of titanium. The molar ratio of barium to the sum of titanium and zirconium (Ba/(Ti+Zr)) was set to 0.920. Other conditions were the same as in Example 1.

(Example 4) In Example 4, the amount of zirconium added was 10 mol with respect to 100 mol of titanium. The molar ratio of barium to the sum of titanium and zirconium (Ba/(Ti+Zr)) was set to 0.900. Other conditions were the same as in Example 1.

(Example 5) In Example 5, the amount of zirconium added was 4 mol with respect to 100 mol of titanium. The molar ratio of barium to the sum of titanium and zirconium (Ba/(Ti+Zr)) was set to 0.960. The amount of gadolinium added was 0.5 mol with respect to 100 mol of titanium. Other conditions were the same as in Example 1.

(Example 6) In Example 6, the amount of zirconium added was 4 mol with respect to 100 mol of titanium. The molar ratio of barium to the sum of titanium and zirconium (Ba/(Ti+Zr)) was set to 0.960. The amount of gadolinium added was 2 mol with respect to 100 mol of titanium. Other conditions were the same as in Example 1.

(Example 7) In Example 7, the amount of zirconium added was 4 mol with respect to 100 mol of titanium. The molar ratio of barium to the sum of titanium and zirconium (Ba/(Ti+Zr)) was set to 0.960. The amount of manganese added was 0.01 mol with respect to 100 mol of titanium. Other conditions were the same as in Example 1.

(Example 8) In Example 8, the amount of zirconium added was 4 mol with respect to 100 mol of titanium. The molar ratio of barium to the sum of titanium and zirconium (Ba/(Ti+Zr)) was set to 0.960. The amount of manganese added was 2 mol with respect to 100 mol of titanium. Other conditions were the same as in Example 1.

(Example 9) In Example 9, the amount of zirconium added was 4 mol with respect to 100 mol of titanium. The molar ratio of barium to the sum of titanium and zirconium (Ba/(Ti+Zr)) was set to 0.960. The amount of manganese added was 0.1 mol with respect to 100 mol of titanium. Other conditions were the same as in Example 1.

(Example 10) In Example 10, vanadium oxide (V₂O₅) powder was further added to barium titanate (BaTiO₃) powder. The amount of zirconium added was 4 mol with respect to 100 mol of titanium. The molar ratio of barium to the sum of titanium and zirconium (Ba/(Ti+Zr)) was set to 0.960. The amount of manganese added was 0.1 mol with respect to 100 mol of titanium. The amount of vanadium added was 0.05 mol with respect to 100 mol of titanium. Other conditions were the same as in Example 1.

(Example 11) In Example 11, vanadium oxide (V₂O₅) powder was further added to barium titanate (BaTiO₃) powder. The amount of zirconium added was 4 mol with respect to 100 mol of titanium. The molar ratio of barium to the sum of titanium and zirconium (Ba/(Ti+Zr)) was set to 0.960. The amount of manganese added was 0.1 mol with respect to 100 mol of titanium. The amount of vanadium added was 0.1 mol with respect to 100 mol of titanium. Other conditions were the same as in Example 1.

(Example 12) In Example 12, vanadium oxide (V₂O₅) powder was further added to barium titanate (BaTiO₃) powder. The amount of zirconium added was 4 mol with respect to 100 mol of titanium. The molar ratio of barium to the sum of titanium and zirconium (Ba/(Ti+Zr)) was set to 0.960. The amount of manganese added was 0.1 mol with respect to 100 mol of titanium. The amount of vanadium added was 0.2 mol with respect to 100 mol of titanium. Other conditions were the same as in Example 1.

(Example 13) In Example 13, vanadium oxide (V₂O₅) powder was further added to barium titanate (BaTiO₃) powder. The amount of zirconium added was 4 mol with respect to 100 mol of titanium. The molar ratio of barium to the sum of titanium and zirconium (Ba/(Ti+Zr)) was set to 0.960. The amount of manganese added was 0.1 mol per 100 mol of titanium. The amount of vanadium added was 0.5 mol with respect to 100 mol of titanium. Other conditions were the same as in Example 1.

(Comparative Example 1) In Comparative Example 1, zirconium was not added. That is, the amount of zirconium added was 0 mol with respect to 100 mol of titanium. The molar ratio of barium to the sum of titanium and zirconium (Ba/(Ti+Zr)) was set to 1.000. Other conditions were the same as in Example 1.

(Comparative Example 2) In Comparative Example 2, the amount of zirconium added was 20 mol with respect to 100 mol of titanium. The molar ratio of barium to the sum of titanium and zirconium (Ba/(Ti+Zr)) was set to 0.800. Other conditions were the same as in Example 1.

(Comparative Example 3) In Comparative Example 3, europium oxide (Eu₂O₃) was added instead of gadolinium oxide (Gd₂O₃). The amount of europium added was 1 mol with respect to 100 mol of titanium. Other conditions were the same as in Example 1.

(Comparative Example 4) In Comparative Example 4, the amount of zirconium added was 4 mol with respect to 100 mol of titanium. The molar ratio of barium to the sum of titanium and zirconium (Ba/(Ti+Zr)) was set to 0.960. No gadolinium oxide was added. Other conditions were the same as in Example 1.

(Comparative Example 5) In Comparative Example 5, the amount of zirconium added was 4 mol with respect to 100 mol of titanium. The molar ratio of barium to the sum of titanium and zirconium (Ba/(Ti+Zr)) was set to 0.960. The amount of gadolinium added was 7 mol with respect to 100 mol of titanium. Other conditions were the same as in Example 1.

(Comparative Example 6) In Comparative Example 6, the amount of zirconium added was 4 mol with respect to 100 mol of titanium. The molar ratio of barium to the sum of titanium and zirconium (Ba/(Ti+Zr)) was set to 0.960. No manganese oxide was added. Other conditions were the same as in Example 1.

(Comparative Example 7) In Comparative Example 7, the amount of zirconium added was 4 mol with respect to 100 mol of titanium. The molar ratio of barium to the sum of titanium and zirconium (Ba/(Ti+Zr)) was set to 0.960. The amount of manganese added was 7 mol with respect to 100 mol of titanium. Other conditions were the same as in Example 1.

(Comparative Example 8) In Comparative Example 8, the amount of zirconium added was 4 mol with respect to 100 mol of titanium. The molar ratio of barium to the sum of titanium and zirconium (Ba/(Ti+Zr)) was set to 0.960. Europium oxide (Eu₂O₃) was added instead of gadolinium oxide (Gd₂O₃). The amount of europium added was 1 mol with respect to 100 mol of titanium. The amount of manganese added was 0.1 mol with respect to 100 mol of titanium. Other conditions were the same as in Example 1.

Table 1 shows the conditions of Examples 1 to 13 and Comparative Examples 1 to 8.

TABLE 1

| | | | Ba/ | RARE | RARE | | |
|---|---|---|---|---|---|---|---|
| | Zr/Ti | Ba/Ti | (Ti + Zr) | ERATH | EARTH/Ti | Mn/Ti | V/Ti |
| COMPARATIVE | 0 | 1 | 1.000 | Gd | 0.01 | 0.005 | 0 |
| EXAMPLE 1 | | | | | | | |
| EXAMPLE 1 | 0.02 | 1 | 0.980 | Gd | 0.01 | 0.005 | 0 |
| EXAMPLE 2 | 0.04 | 1 | 0.960 | Gd | 0.01 | 0.005 | 0 |
| EXAMPLE 3 | 0.08 | 1 | 0.920 | Gd | 0.01 | 0.005 | 0 |
| EXAMPLE 4 | 0.1 | 1 | 0.900 | Gd | 0.01 | 0.005 | 0 |
| COMPARATIVE | 0.2 | 1 | 0.800 | Gd | 0.01 | 0.005 | 0 |
| EXAMPLE 2 | | | | | | | |
| COMPARATIVE | 0.02 | 1 | 0.980 | Eu | 0.01 | 0.005 | 0 |
| EXAMPLE 3 | | | | | | | |
| COMPARATIVE | 0.04 | 1 | 0.960 | Gd | 0 | 0.005 | 0 |
| EXAMPLE 4 | | | | | | | |
| EXAMPLE 5 | 0.04 | 1 | 0.960 | Gd | 0.005 | 0.005 | 0 |
| EXAMPLE 6 | 0.04 | 1 | 0.960 | Gd | 0.02 | 0.005 | 0 |
| COMPARATIVE | 0.04 | 1 | 0.960 | Gd | 0.07 | 0.005 | 0 |
| EXAMPLE 5 | | | | | | | |
| COMPARATIVE | 0.04 | 1 | 0.960 | Gd | 0.01 | 0 | 0 |
| EXAMPLE 6 | | | | | | | |
| EXAMPLE 7 | 0.04 | 1 | 0.960 | Gd | 0.01 | 0.0001 | 0 |
| EXAMPLE 8 | 0.04 | 1 | 0.960 | Gd | 0.01 | 0.02 | 0 |
| COMPARATIVE | 0.04 | 1 | 0.960 | Gd | 0.01 | 0.07 | 0 |
| EXAMPLE 7 | | | | | | | |
| COMPARATIVE | 0.04 | 1 | 0.960 | Eu | 0.01 | 0.001 | 0 |
| EXAMPLE 8 | | | | | | | |
| EXAMPLE 9 | 0.04 | 1 | 0.960 | Gd | 0.01 | 0.001 | 0 |
| EXAMPLE 10 | 0.04 | 1 | 0.960 | Gd | 0.01 | 0.001 | 0.0005 |
| EXAMPLE 11 | 0.04 | 1 | 0.960 | Gd | 0.01 | 0.001 | 0.001 |
| EXAMPLE 12 | 0.04 | 1 | 0.960 | Gd | 0.01 | 0.001 | 0.002 |
| EXAMPLE 13 | 0.04 | 1 | 0.960 | Gd | 0.01 | 0.001 | 0.005 |

The average diameter of the dielectric grains in the dielectric layer was measured. Specifically, the multilayer ceramic capacitor was cut parallel to the end face on which the external electrode was formed, and the cross section was polished. The cross section corresponds to the YZ cross section. The grain diameter of the dielectric grains was measured based on a cross-sectional image of the dielectric layer taken with a scanning electron microscope (SEM) for the cross-section. Based on the SEM image, the maximum length of the dielectric grain in the stacking direction was defined as the grain diameter, and the arithmetic mean value of each measured grain diameter was defined as the average diameter of the dielectric grains. The polishing position here was set in a central region divided into five equal parts in the X-axis direction from the end faces of the both external electrodes so as to be near the center.

The average diameter of the dielectric grains was 0.26 μm in Example 1, 0.25 μm in Example 2, 0.25 μm in Example 3, 0.25 μm in Example 4, 0.26 μm in Example 5, 0.27 μm in Example 6, 0.23 μm in Example 7, 0.2 μm in Example 8, 0.25 μm in Example 9, 0.25 μm in Example 10, 0.25 μm in Example 11, 0.25 μm in Example 12, 0.25 μm in Example 13, 0.65 μm in Comparative Example 1, 0.25 μm in Comparative Example 2, 0.27 μm in Comparative Example 3, 0.25 μm in Comparative Example 4, 0.29 μm in Comparative Example 5, 0.25 μm in Comparative Example 6, 0.19 μm in Comparative Example 7, and 0.25 μm in Comparative Example 8.

The multilayer ceramic capacitors of Examples 1 to 13 and Comparative Examples 1 to 8 were allowed to stand for 2 hours in a constant temperature bath at 150° C., then taken out to room temperature, and 24 hours later, the capacity and tan δ were measured using an LCR meter at 1 KHz and 1 Vrms. Thereafter, the multilayer ceramic capacitors were placed in a chamber for measuring temperature characteristics, and the capacity and tan δ at each temperature were measured while increasing the temperature from −55° C. to 150° C. At this time, a multilayer ceramic capacitor in which grain growth has significantly progressed exhibits an abnormally large value (>12%) of tan δ. In this test, those in which such an abnormality was observed in tan & were judged to be defective due to short circuit. This is because a short-circuited multilayer ceramic capacitor cannot be used as an electronic component.

For the capacity thus measured, the rate of change in capacity was calculated at each temperature with reference to the capacity value at 25° C., and it was determined whether the amount of change was within the X5R standard in the EIA standard for multilayer ceramic capacitors. If the change was within the X5R standard, the sample was judged as good “o”. If the change was not within the X5R standard, the sample was judged as bad “x”.

The DC resistivity p (Ω·cm) can be calculated from the formula p=(V/I)×(S/t), where the DC voltage at the time of measurement is V (V). “S” is the cross-sectional area, and “t” is the distance between the electrodes. The direct current “I” can be measured using an insulation resistance meter. In the measurement, it is necessary to determine the measurement voltage, but it can be determined as the measurement electric field depending on the thickness of the dielectric layer. As an example, the multilayer ceramic capacitor was held in the constant temperature bath at 125° C. for 30 minutes, insulation from the surroundings was ensured using a ceramic insulator. The measurement was carried out through an electric wire connected from the constant temperature bath to the external electrode. When the electric field was 10 V/μm, that is, the thickness of the dielectric layer was 2 μm, 20 V was applied for 30 seconds, the DC current “I” was measured, and the DC resistivity “ρ” (Ω·cm) was calculated. The results are shown in Table 2.

TABLE 2

| | AVERAGE | | DIELECTRIC | | |
|---|---|---|---|---|---|
| | GRAIN | | CONSTANT | | |
| | DIAMETER | tanδ | (ROOM | | RESISTIVITY |
| | (μm) | (%) | TEMPERATURE) | X5R | (Ω · cm) |
| COMPARATIVE | 0.65 | 16 | SHORT | — | — |
| EXAMPLE 1 | | | | | |
| EXAMPLE 1 | 0.26 | 6.4 | 3950 | ∘ | 2 × 10¹¹ |
| EXAMPLE 2 | 0.25 | 5.8 | 2159 | ∘ | 5 × 10¹⁰ |
| EXAMPLE 3 | 0.25 | 5.9 | 2044 | ∘ | 4 × 10¹⁰ |
| EXAMPLE 4 | 0.25 | 6.0 | 1616 | ∘ | 3 × 10¹⁰ |
| COMPARATIVE | 0.25 | 6.2 | 1400 | x | 2 × 10¹⁰ |
| EXAMPLE 2 | | | | | |
| COMPARATIVE | 0.27 | 6.1 | 3862 | ∘ | 3 × 10¹⁰ |
| EXAMPLE 3 | | | | | |
| COMPARATIVE | 0.25 | 40.0 | SHORT | — | 0 |
| EXAMPLE 4 | | | | | |
| EXAMPLE 5 | 0.26 | 6.2 | 3550 | ∘ | 1 × 10¹¹ |
| EXAMPLE 6 | 0.27 | 7.5 | 3650 | ∘ | 2 × 10¹¹ |
| COMPARATIVE | 0.29 | 8.5 | 3700 | ∘ | 1 × 10⁸ |
| EXAMPLE 5 | | | | | |
| COMPARATIVE | 0.25 | 40.000 | SHORT | — | |
| EXAMPLE 6 | | | | | |
| EXAMPLE 7 | 0.23 | 4.0 | 3970 | ∘ | 8 × 10¹⁰ |
| EXAMPLE 8 | 0.2 | 3.2 | 2500 | ∘ | 3 × 10¹¹ |
| COMPARATIVE | 0.19 | 2.8 | 1200 | ∘ | 1 × 10¹⁰ |
| EXAMPLE 7 | | | | | |
| COMPARATIVE | 0.25 | 6.1 | 2750 | ∘ | 1 × 10⁵ |
| EXAMPLE 8 | | | | | |
| EXAMPLE 9 | 0.25 | 5.9 | 2877 | ∘ | 1 × 10⁶ |
| EXAMPLE 10 | 0.25 | 5.6 | 2813 | ∘ | 2 × 10⁹ |
| EXAMPLE 11 | 0.25 | 5.3 | 2795 | ∘ | 5 × 10⁹ |
| EXAMPLE 12 | 0.25 | 5.2 | 2660 | ∘ | 5 × 10⁹ |
| EXAMPLE 13 | 0.25 | 4.4 | 2296 | ∘ | 3 × 10⁹ |

The results of Comparative Examples 1 and 2 and Examples 1 to 4 will be verified. In Comparative Examples 1 and 2 and Examples 1 to 4, the amount of zirconium added was varied. In Comparative Example 1 in which zirconium was not added, the tan & after firing was 16%, which was a significantly high value. When the microstructure of this sample was observed, it was found that the grains had grown significantly, and the average crystal grain diameter in the dielectric layer was 0.65 μm. This remarkable grain growth is considered to be the cause of the abnormally high tan δ. The multilayer ceramic capacitor exhibiting such an abnormally high tan δ cannot be used as an electronic component, and its capacity and insulation cannot be evaluated correctly because its insulation properties are extremely poor in the first place. Therefore, electrical characterization was not performed on these samples.

On the other hand, in Examples 1 to 4 in which the amount of zirconium added to 100 mol of titanium was 2 mol or more and 10 mol or less, tan δ showed a value of about 5% to 6%, making it possible to measure capacity and insulation. Further, in Examples 1 to 4, the resistivity was 2×10¹¹ to 3×10¹⁰ Ω·cm. On the other hand, in Comparative Example 2 in which the amount of zirconium added was 20 mol with respect to 100 mol of titanium, the temperature characteristics of electrostatic capacity did not satisfy X5R. Furthermore, the dielectric constant of Comparative Example 2 was a significantly low value of 1400. This is thought to be because the amount of zirconium was large and the zirconium diffused into the core, making it impossible to maintain the core-shell structure. These results show that the amount of zirconium added to 100 mol of titanium is required to be 2 mol or more and 10 mol or less. Note that when the amount added is converted into a Ba/(Ti+Zr) ratio, it is found that 0.90≤Ba/(Ti+Zr)≤0.98 is required.

Next, the results of Comparative Example 3 and Example 1 will be verified. In Comparative Example 3, europium was added as a rare earth element. When the insulation property of Comparative Example 3 was measured, a resistivity was found to be 3×10¹⁰ Ω·cm. On the other hand, in Example 1, gadolinium was added as a rare earth element. Example 1 in which gadolinium was added showed a resistivity of 2×10¹¹ Ω·cm. This result shows that Example 1 has higher insulation properties than Comparative Example 3. In Comparative Example 3, since the added europium can be in a divalent or trivalent state, it is thought that hopping conduction caused by valence fluctuation became significant, resulting in deterioration in insulation properties. On the other hand, gadolinium can only have a valence of 3, and it is thought that the absence of valence fluctuations contributed to the improvement in insulation.

Next, the results of Comparative Examples 4 and 5 and Examples 5 and 6 will be verified. In Comparative Examples 4 and 5 and Examples 5 and 6, the amount of gadolinium added was changed. In Comparative Example 4, no gadolinium was added. Comparative Example 4 showed an abnormally high value of tan δ=40%. This is because barium titanate was reduced because the amount of rare earth element added was too small. On the other hand, in Examples 5 and 6, the amount of gadolinium added was 0.5 mol and 2 mol with respect to 100 mol of titanium, respectively. Examples 5 and 6 showed normal tan δ (<12%), and high insulation properties were obtained. On the other hand, in Comparative Example 5, the amount of gadolinium added was 7 mol with respect to 100 mol of titanium, and the insulation properties of this sample were slightly worse than those of Examples 5 and 6. This is considered to be because gadolinium substituted as a solid solution at the barium titanate A site and acted as a donor. These results show that the amount of gadolinium added to 100 mol of titanium is required to be 0.5 mol or more and 2 mol or less.

Next, the results of Comparative Examples 6 and 7 and Examples 7 and 8 will be verified. In Comparative Examples 6 and 7 and Examples 7 and 8, the amount of manganese added was changed. In Comparative Example 6, no manganese was added. Comparative Example 6 showed an abnormally high value of tan δ=40%. This is because barium titanate was reduced because the amount of manganese added was too small. On the other hand, in Examples 7 and 8, the amount of manganese added was 0.01 mol and 2 mol with respect to 100 mol of titanium, respectively. Examples 7 and 8 showed normal tan δ (<12%), and high insulation properties were obtained. On the other hand, in Comparative Example 7, the amount of manganese added was 7 mol with respect to 100 mol of titanium. In Comparative Example 7, the insulation properties were slightly worse than in Examples 7 and 8. This is considered to be due to hopping conduction caused by the valence fluctuation of manganese. Furthermore, the dielectric constant of Comparative Example 7 was a significantly low value of 1200. This is considered to be due to the fact that manganese acts as an acceptor and oxide ion vacancies were generated. These results show that the amount of manganese added to 100 mol of titanium is required to be 0.01 mol or more and 2 mol or less.

In Comparative Example 8 and Examples 9 to 13, the amount of manganese added was 0.1 mol with respect to 100 mol of titanium. Furthermore, in Comparative Example 8, europium was added as a rare earth element. The resistivity of Comparative Example 8 was 1×10⁵ Ω·cm. On the other hand, in Example 9, gadolinium was added as a rare earth element. The resistivity of Example 9 was 1×10⁶ Ω·cm, which was higher than that of Comparative Example 8 in which europium was added.

In Examples 9 to 13, the amount of vanadium added was varied, and the amount of vanadium added was 0 to 5 mol with respect to 100 mol of titanium. When the amount of vanadium added to 100 mol of titanium was from 0 to 0.2 mol, the resistivity increased as the amount of vanadium increased. This is thought to be because vanadium was distributed at grain boundaries and grain boundary multiple points, increasing the width of the double Schottky barrier at grain boundaries, and making it difficult for tunnel current to occur.

Although the embodiments of the present invention have been described in detail, it is to be understood that the various change, substitutions, and alterations could be made hereto without departing from the spirit and scope of the invention.

1. A dielectric material comprising:
a main component, a first subcomponent, a second subcomponent, and a third subcomponent,
wherein the main component includes barium titanate,
wherein the first subcomponent includes zirconium of 2 mol or more and 10 mol or less with respect to 100 mol of titanium of the dielectric material, so that a molar ratio of barium to a sum of titanium and zirconium in the dielectric material is more than 0.90 and less than 0.98,
wherein the second subcomponent includes gadolinium of 0.5 mol or more and 2 mol or less with respect to 100 mol of titanium in the dielectric material,
wherein the third subcomponent includes 0.01 mol or more and 2 mol or less of manganese with respect to 100 mol of titanium in the dielectric material, and
wherein the dielectric material contains neither ytterbium nor ruthenium.

2. The dielectric material as claimed in claim 1, further comprising:
a plurality of crystal grains each including a core portion and a shell portion surrounding the core portion,
wherein a total concentration of zirconium and manganese in the core portion is lower than a total concentration of zirconium and manganese in the shell portion.

3. The dielectric material as claimed in claim 1, further comprising:
a rare earth element of which an amount is smaller than an amount of gadolinium.

4. The dielectric material as claimed in claim 1, further comprising:
a fourth subcomponent including 0.5 mol or less of vanadium with respect to 100 mol of titanium in the dielectric material.

5. The dielectric material as claimed in claim 4, wherein the fourth subcomponent includes 0.05 mol or more and 0.2 mol or less of vanadium with respect to 100 mol of titanium in the dielectric material.

6. The dielectric material as claimed in claim 4, wherein a valence of vanadium in the fourth subcomponent is 5.

7. The dielectric material as claimed in claim 4, further comprising:
a plurality of crystal grains each including a core portion and a shell portion surrounding the core portion,
wherein a total concentration of zirconium, manganese and vanadium in the core portion is lower than a total concentration of zirconium, manganese and vanadium in the shell portion.

8. The dielectric material as claimed in claim 7, wherein the third subcomponent and the fourth subcomponent exist on a grain boundary of the plurality of crystal grains.

9. The dielectric material as claimed in claim 7, wherein the third subcomponent and the fourth subcomponent exist on a grain boundary multiple points.

10. The dielectric material as claimed in claim 7 further comprising:
a fifth subcomponent including silicon,
wherein the fifth subcomponent exists on a grain boundary of the plurality of crystal grains.

11. The dielectric material as claimed in claim 10, wherein the fifth subcomponent exists on a grain boundary multiple point of the plurality of crystal grains.

12. The dielectric material as claimed in claim 1, further comprising:
a sub crystal grain of at least one of BaTi₂O₅, BaTi₄O₉, BaTi₅O₁₁, BaTi₆O₁₃, Ba₄Ti₁₁O₂₆, Ba₄Ti₁₂O₂₇, Ba₄Ti₁₃O₃₀, Ba₄Ti₁₄O₂₇ or Ba₆Ti₁₇O₄₀.

13. A multilayer ceramic electronic device comprising:
a dielectric material as claimed in claim 1.

14. The multilayer ceramic electronic device as claimed in claim 13, further comprising:
a plurality of internal electrodes facing each other;
a dielectric layer of the dielectric material and is sandwiched by the plurality of internal electrodes; and
an external electrode electrically connected to a part of the plurality of internal electrodes.

15. The multilayer ceramic electronic device as claimed in claim 14,
wherein the dielectric material comprises:
a plurality of crystal grains each including a core portion and a shell portion surrounding the core portion,
wherein a total concentration of zirconium and manganese in the core portion is lower than a total concentration of zirconium and manganese in the shell portion.

16. The multilayer ceramic electronic device as claimed in claim 14,
wherein the dielectric material comprises:
a rare earth element of which an amount is smaller than an amount of gadolinium.

17. The multilayer ceramic electronic device as claimed in claim 14,
wherein the dielectric material comprises:
a fourth subcomponent including 0.5 mol or less of vanadium with respect to 100 mol of titanium in the dielectric material.

18. The multilayer ceramic electronic device as claimed in claim 17,
wherein the fourth subcomponent includes 0.05 mol or more and 0.2 mol or less of vanadium with respect to 100 mol of titanium in the dielectric material.

19. The multilayer ceramic electronic device as claimed in claim 17, wherein a valence of vanadium in the fourth subcomponent is 5.

20. The multilayer ceramic electronic device as claimed in claim 17,
wherein the dielectric material further comprises:
a plurality of crystal grains each including a core portion and a shell portion surrounding the core portion,
wherein a total concentration of zirconium, manganese and vanadium in the core portion is lower than a total concentration of zirconium, manganese and vanadium in the shell portion.
